(19) United States
(12) Patent Application Publication
(10) Pub. No.: US 2011/0188265 A1
(43) Pub. Date: Aug. 4, 2011

(54) ILLUMINATION DEVICE

(75) Inventors: Hiroyuki Kumasawa, Ehime (JP); Akiyoshi Kanemitsu, Ehime (JP); Tomonori Miyamoto, Osaka (JP); Motohiro Yamahara, Nara (JP)

(73) Assignee: SUMITOMO CHEMICAL COMPANY, LIMITED, Chuo-ku, Tokyo (JP)

(21) Appl. No.: 13/058,233

(22) PCT Filed: Aug. 10, 2009
(86) PCT No.: PCT/JP2009/064132

§ 371 Date: Apr. 18, 2011

(30) Foreign Application Priority Data
Aug. 12, 2008 (JP) 2008-207552
Nov. 13, 2008 (JP) 2008-290493

(51) Int. Cl. F21V 7/22; F21S 6/00

(52) U.S. Cl. 362/611; 362/257

(57) ABSTRACT

The luminance in the front direction is enhanced in an illumination device provided with a light source, a light diffusion means, and a light-collecting means disposed in this order. The light source 1 is provided with a rectangular parallelepiped case 12 having an opening 121 and a plurality of CCFLs 11 disposed in the case 12. A light diffusion plate 2 is mounted so as to close the opening 121 of the case 12. The light-collecting means 3 has two prism films 31 and 32 which are disposed on the light-exiting surface of the light diffusion plate 2 such that ridge lines of linear prisms are orthogonal to each other.

### TECHNICAL FIELD

The present invention relates to an illumination device provided with a light source, a light diffusion means, and a light-collecting means disposed in this order.

### BACKGROUND ART

A widely used conventional illumination device is provided with a case 12 having a surface opening and an inner surfaces that exhibit a light reflection effect; a plurality of cold cathode fluorescent lamps (CCFLs) 11 disposed in parallel in the case 12; a light diffusion plate 2 mounted so as to close the opening of the case 12; and a prism film 30 disposed so as to overlap the light-exiting surface of the light diffusion plate 2, as shown in FIG. 7 (refer to Patent Literature 1, for example).

### CITATION LIST

### Patent Literature

[Patent Literature 1] Japanese Unexamined Patent Application Publication No. H7-141908

### SUMMARY OF INVENTION

### Technical Problem

In the conventional illumination device, however, light is diffused toward a wide range of direction from the light diffusion means (light diffusion plate or light guide plate). The luminance is then insufficient in the perpendicular direction of the light-exiting surface of the light diffusion means (hereinafter may be referred to as front direction). Thus, an illumination device having improved luminance in the front direction is demanded.

In view of such a technical background, an object of the present invention is to provide an illumination device excellent in luminance in the front direction.

### Solution to Problem

An illumination device according to the present invention includes a light source, a light diffusion means, and a light-collecting means disposed in this order. The light-collecting means has two prism films provided with a plurality of linear prisms disposed in parallel, each prism having a triangular cross section on a light incident surface, and the two prism films are disposed such that ridge lines of the linear prisms are orthogonal to each other. The term “orthogonal” throughout the specification refers to an angle within the range of 90°±2°.

The light diffusion means may be a light diffusion plate, and the light source may be provided so as to face the light diffusion plate. It is preferred that the light source include a plurality of linear light source elements disposed in parallel.

Furthermore, the light diffusion means may be a light guide plate, and the light source may be provided so as to face a side surface of the light guide plate.

In addition, it is preferred that the light incident surfaces of the two prism films have a mean center-line roughness Ra of 0.3 μm or less and a ten-point mean roughness Rz of 1 μm or less.

### Advantageous Effects of Invention

The two prism films are disposed such that the ridge lines of the linear prisms are orthogonal to each other in the illumination device of the present invention. Thus, the light emitted from the light diffusion means is collected in the perpendicular direction of a light-exiting surface, and the luminance in the front direction of the light-exiting surface is enhanced.

### BRIEF DESCRIPTION OF DRAWINGS

FIG. 1 is a schematic view illustrating an example of an illumination device according to the present invention;

FIG. 2 is a perspective view illustrating placement of two prism films in the illumination device of FIG. 1;

FIG. 3 is a perspective view illustrating another example of placement of two prism films;

FIG. 4 is a schematic view illustrating an alternative example of the illumination device according to the present invention;

FIG. 5 includes front views illustrating examples of placement of the prism films in a case where a plurality of point light source elements 13 are disposed in parallel in two directions of a matrix in a direct under type illumination device;

FIG. 6 illustrates a method of measuring luminance; and

FIG. 7 is a schematic view illustrating a conventional illumination device.

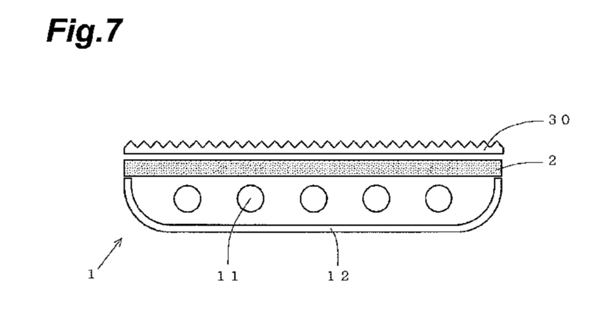

### DESCRIPTION OF EMBODIMENTS

An illumination device according to the present invention is explained below with reference to the drawings. The present invention, however, is by no means limited to the embodiments below.

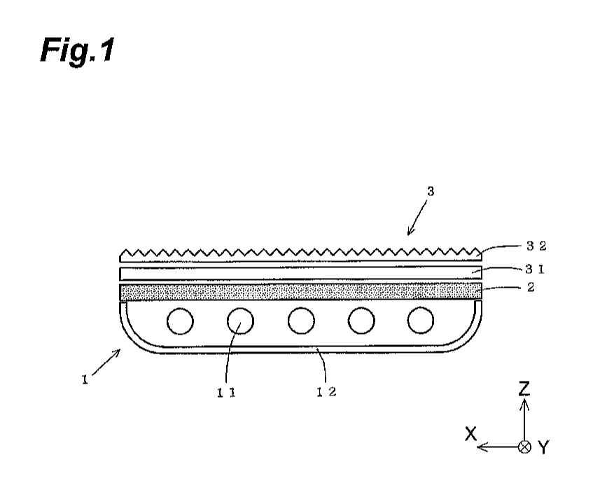

FIG. 1 is a schematic view illustrating an embodiment of an illumination device according to the present invention. The illumination device in FIG. 1, which is a commonly called direct type illumination device, has a light source 1, a light diffusion plate 2, and a light-collecting means 3. The light source 1 is provided with a rectangular parallelepiped case 12 having an opening 121 and a plurality of CCFLs 11 disposed in the case 12 in parallel as a linear light source. The light diffusion plate 2 is mounted so as to close the opening 121 of the case 12. The light-collecting means 3 has two prism films 31 and 32, which are disposed so as to overlap the light-exiting surface of the light diffusion plate 2.

The case 12 is composed of a resin or metal material. In view of reflection of the light emitted from the CCFLs 11 by the inner surface of the case, it is preferred that at least the inner surface of the case have a white or silver color.

In addition to the CCFLs 11, hot-cathode tubes or linearly disposed LEDs may be used as the linear light source. The number of disposed linear light source elements is not particularly limited. In view of prevention of uneven luminance on a light emitting surface, however, it is preferred that the distance between the centers of adjacent linear light source elements be within a range of 15 and 150 mm.

The light diffusion plate 2, which diffuses and emits the light emitted from the light source 1, is generally composed of a light-transmissive resin as a base material in which a diffusing agent is dispersed and mixed. Examples of the base material of the light diffusion plate may include polycarbonates; methacrylate resins; methyl methacrylate-styrene copolymer resins; acrylonitrile-styrene copolymer resins; methacrylate-styrene copolymer resins; polystyrenes; polyvinyl chlorides; polyolefins, such as polypropylene and polymethylpentene; cyclic polyolefins; polyester resins, such as polyethylene terephthalate, polybutylene terephthalate, and polyethylene naphthalate; polyamide resins; polyarylates; and polyimides. The diffusing agent dispersed into the base material may be microparticles composed of a material having a refractive index different from that of the base material. Examples of such a diffusing agent include organic microparticles different from that for the base material such as acrylic resins, melamine resins, polyethylenes, polystyrenes, organic silicone resins, and acrylic-styrene copolymers; and inorganic microparticles such as calcium carbonate, silica, aluminum oxide, barium carbonate, barium sulfate, titanium oxide, and glass. One type thereof may be used, or two or more types thereof may be mixed to be used. Furthermore, organic polymer balloons or glass hollow beads may be used as a diffusing agent. It is preferred that the average particle size of the diffusing agent be within a range of 0.5 μm and 30 μm. The shape of the diffusing agent may not only be spherical, but also be flat, platy, or acicular.

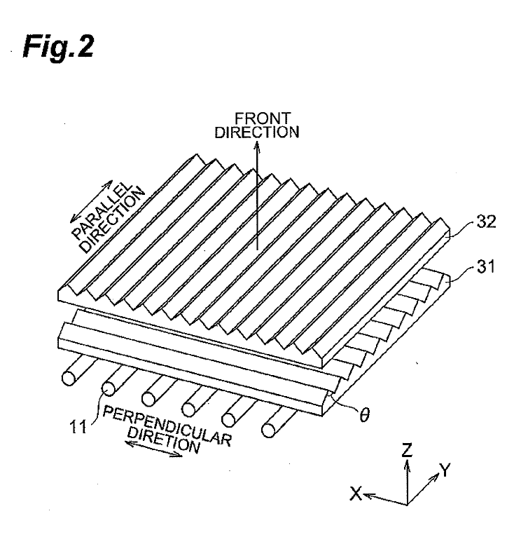

The two prism films 31 and 32 each have a flat light incident surface and a plurality of linear prisms each having a triangle cross-sectional shape on the light-exiting surface. As shown in FIG. 2, the prism film 31 is disposed such that the ridge lines of the linear prisms are perpendicular to the longitudinal direction (Y direction) of the CCFLs 11; and the prism film 32 is disposed such that the ridge lines of the linear prisms are orthogonal to those of the prism film 31. The vertex angle θ of the linear prism having a triangle cross-sectional shape is within a range of 60° to 120°, preferably 90° to 110°. The triangle cross-sectional shape may be equilateral or inequilateral. In order to collect light in the front direction, however, an isosceles triangle is desired. A configuration is preferred in which an adjacent isosceles triangle is sequentially arrayed adjacent to a base corresponding to a vertex angle, and ridge lines, which are rows of vertex angles, form long axes so as to be provided substantially in parallel with each other. In this case, the vertex angle and the base angle may have curvature unless the light collecting capability is significantly reduced. The distance between the ridge lines is normally within a range of 10 μm and 500 μm, preferably within a range of 30 μm and 300 μm.

As shown in FIG. 1, the perpendicular line of the light-exiting surface of the light diffusion plate 2 is provided substantially in parallel with the Z axis. Furthermore, the perpendicular line of the light incident surfaces of the prism films 31 and 32 is provided substantially in parallel with the Z axis.

It is preferred that the light incident surfaces of the prism films 31 and 32 be each flat. With respect to the flatness of the prism film on the light incident surface, the Ra (mean center-line roughness) measured in accordance with JIS B0601-1994 may be, for example, 0.3 μm or less, preferably 0.1 μm or less, more preferably 0.05 μm or less. Furthermore, the Rz (center-line mean roughness) measured in accordance with JIS B0601-1994 may be, for example, 1 μm or less, preferably 0.5 μm or less.

The above-described flat surface may be produced through a mirror-polishing treatment with abrasive to a surface of a mold forming said flat surface followed by a heat compressing process of the resin in the resulting mold.

A flat light incident surface of the prism film is preferred in view of a tendency of an increase in the luminance in the front direction.

Examples of the material for the prism films 31 and 32 may include polycarbonate resins, ABS resins, methacrylate resins, methyl methacrylate-styrene copolymer resins, polystyrene resins, acrylonitrile-styrene copolymer resins, and polyolefin resins, such as polyethylene and polyethylene. A regular molding process of thermoplastic resin may be employed as a method of producing the prism film. For example, production may be performed with a heat compressing process using a mold. The thickness of the prism film is normally 0.1 to 15 mm, preferably 0.5 to 10 mm.

In the illumination device having such a configuration, the light emitted from the CCFLs 11 enters the light diffusion plate 2 directly or after being reflected by the internal peripheral surface of the case 12. The light entering the light diffusion plate 2 is diffused and emitted. Then, in a perpendicular cross section (ZY plane in FIG. 2) parallel to the longitudinal direction of the CCFLs 11, the light obliquely entering the lower surface of the prism film 31 emerges after its path is bent to the front direction. Furthermore, in a perpendicular cross section (XZ plane in FIG. 2) perpendicular to the longitudinal direction of the CCFLs 11, the light obliquely entering the lower surface of the prism film 32 emerges after its path is bent to the front direction similar to above. Thus, the light passing through the two prism films 31 and 32 is collected in the perpendicular direction to the light-exiting surface of the light diffusion plate 2 as a light diffusion means, namely in the front direction (Z direction in FIG. 2), with regard to both perpendicular cross sections; and the luminance in the front direction is enhanced.

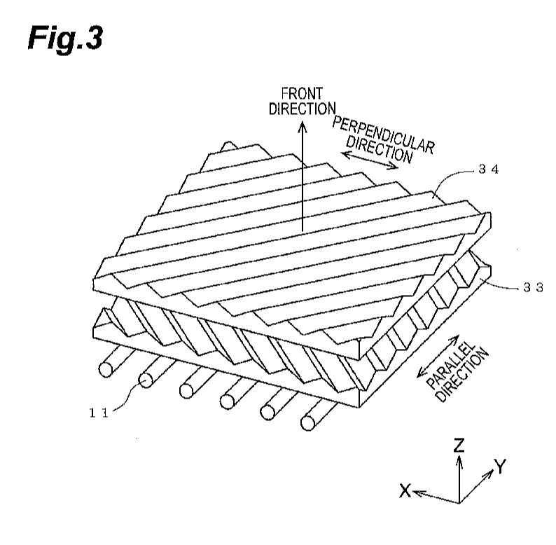

The placement of the two prism films 31 and 32 is not particularly limited as long as the ridge lines of the linear prisms are disposed orthogonal to each other. As shown in FIG. 3, for instance, a prism film 33 may be disposed such that ridge lines of linear prisms thereof are provided at an angle of 45° from a direction parallel to the CCFLs 11; and a prism film 34 may be disposed such that ridge lines of linear prisms thereof are provided at an angle of 135° from the direction parallel to the CCFLs 11. In the case where a prism film has a quadrangular shape when it is viewed from the front direction, it is preferred that prism films be disposed such that ridge lines of linear prisms are provided in parallel with or incline by an angel of 45° or 135° from the sides of the prism films, as shown in FIGS. 2 and 3.

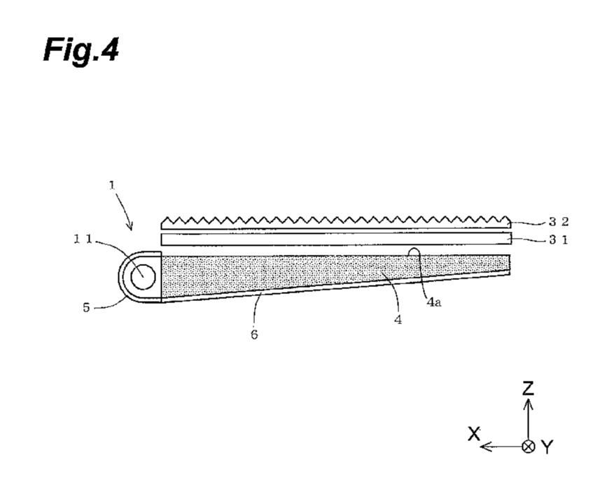

An alternative example of the illumination device according to the present invention is shown in FIG. 4. The illumination device in FIG. 4 is a commonly called side lit illumination device. The illumination device is different from the direct type illumination device shown in FIG. 1 in that a light guide plate 4 is used as a light diffusion means and that a light source 1 is disposed to face to a side surface of the light guide plate 4. Specifically, the illumination device in FIG. 4 has the light guide plate 4 composed of a light-transmissive member, a CCFL 11 provided to face to the side surface of the light guide plate 4, a reflecting tube 5 having a U-shaped cross section and mounted so as to cover the periphery of the CCFL 11, and a reflecting plate 6 mounted on the rear surface of the light guide plate 4. The light emitted from the CCFL 11 enters the inside of the light guide plate 4 from the side surface directly or after being reflected by the reflecting tube 5. The light entering the inside of the light guide plate 4 emerges to the outside from a light-exiting surface 4a of the light guide plate 4 by the reflecting plate 6 or unevenness (not shown in the drawing) formed on the rear surface of the light guide plate 4. The luminance of the light emerging from the light-exiting surface 4a of the light guide plate 4 is normally maximum in a direction slightly inclining from the perpendicular direction of the light-exiting surface 4a, or the front direction. Although the luminance in the front direction is not so high, the path of the light emerging from the light guide plate 4 is bent by two prism films 31 and 32 disposed on the light guide plate 4 similar to above, and thus the luminance in the front direction is improved.

In the case of the side lit illumination device, it is preferred that the two prism films 31 and 32 be disposed such that the ridge lines of the prism films 31 and 32 incline by angles of 45° and 135°, respectively, from the CCFL 11.

In this embodiment, the CCFL 11 is disposed so as to face to one side surface of the light guide plate 4. CCFLs 11 may be disposed to face two side surfaces facing each other of the light guide plate. Alternatively, CCFLs 11 may be disposed to three or four side surfaces of the light guide plate. In addition to the CCFL 11, a hot-cathode tube or an LED may be used as the light source 1.

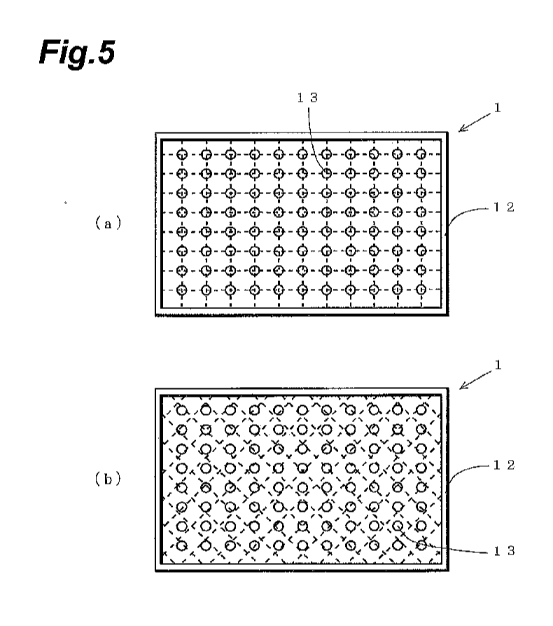

In the case where a point light source such as an LED is used as the light source 1, the arrangement of the two prism films 31 and 32 is not particularly limited, either, as long as the ridge lines of the linear prisms are disposed orthogonal to each other. For example, in the case where a plurality of point light source elements 13 are disposed in parallel to each other in two directions of a matrix in the direct illumination device as shown in FIG. 5, it is recommended that the two prism films 31 and 32 be disposed such that the ridge lines of the linear prisms (represented by a broken line in the drawing) are in parallel with the directions of the matrix of the point light source elements 13 (5(a) in the drawing); or that the two prism films 31 and 32 be disposed such that the ridge lines of the linear prisms (represented by a broken line in the drawing) incline by angles of 45° and 135°, respectively, from the directions of the matrix of the point light source elements 13 (5(b) in the drawing).

### EXAMPLES

The present invention is explained below in further detail by way of examples. The present invention is by no means limited to the examples below.

### Example 1

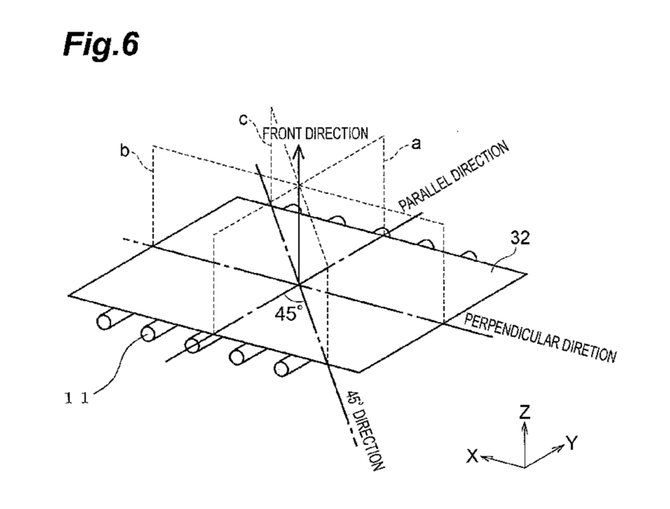

In an illumination device having a configuration shown in FIGS. 1 and 2, prism films 31 and 32 were provided with a plurality of parallel triangular prisms having a vertex angle θ of 95° at a distance between ridge lines, as rows of vertex angles, of 50 μm on a light exiting surface, and a light incident surface being a flat surface. The flat surface measured in accordance with JIS B0601-1994 had an Ra (mean center-line roughness) of 0.01 μm and an Rz (mean center-line roughness) of 0.08 μm. The light diffusion plate 2 had a total light transmittance of 75%. Then, a luminance distribution of the light emerging from the prism film 32 was measured. Specifically, as shown in FIG. 6, the luminance in the directions of 15°, 30°, and 45° from the front direction (Z axis direction) was measured in a perpendicular cross section a (ZY plane) parallel to the CCFLs 11 and the Z axis, a cross section b (ZX plane) perpendicular to the CCFLs 11, and a perpendicular cross section c at a direction of 45° from the CCFLs 11 and parallel to the Z axis. The observed results are shown in Table 1. The luminance in each direction was represented in percentage relative to the luminance in the front direction being set 100%.

### Example 2

The luminance was measured in the directions of 15°, 30°, and 45° from the front direction in each cross section as in Example 1, except that two prism films used had ridge lines of linear prisms at angles of 45° and 135°, respectively, from the CCFLs. The observed results are shown in Table 1.

### Example 3

The luminance distribution was measured as in Example 1, except that a light diffusion plate having a total light transmittance of 65% was used. The observed results are shown in Table 1.

### Example 4

The luminance distribution was measured as in Example 2, except that a light diffusion plate having a total light transmittance of 65% was used. The observed results are shown in Table 1.

### Example 5

The luminance distribution was measured as in Example 1, except that an “RBEF prism film” (Sumitomo 3M Limited) having a round vertex was used as a prism film. The observed results are shown in Table 1.

### Example 6

The luminance distribution was measured as in Example 2, except that an “RBEF prism film” having a round vertex was used as a prism film. The observed results are shown in Table 1.

### Example 7

The luminance distribution was measured as in Example 5, except that a light diffusion plate having a total light transmittance of 65% was used. The observed results are shown in Table 1.

### Example 8

The luminance distribution was measured as in Example 6, except that a light diffusion plate having a total light transmittance of 65% was used. The observed results are shown in Table 1.

### Comparative Example 1

Only one of the prism films in Example 1 was placed on a light diffusion plate having a total light transmittance of 75% such that the ridge lines of the linear prisms were in parallel with the CCFLs. The luminance distribution was measured as in Example 1. The observed results are shown in Table 2.

### Comparative Example 2

The luminance distribution was measured as in Comparative Example 1, except that an “RBEF prism film” having a round vertex was used as a prism film. The observed results are shown in Table 2.

### Comparative Example 3

The luminance distribution was measured as in Example 1, only with a light diffusion plate having a total light transmittance of 75% and without a prism film. The observed results are shown in Table 2.

### Comparative Example 4

The luminance distribution was measured as in Comparative Example 1, except that a light diffusion plate having a total light transmittance of 65% was used. The observed results are shown in Table 2.

### Comparative Example 5

The luminance distribution was measured as in Comparative Example 2, except that a light diffusion plate having a total light transmittance of 65% was used. The observed results are shown in Table 2.

### Comparative Example 6

The luminance distribution was measured as in Example 1, except that only a light diffusion plate having a total light transmittance of 65% was used without a prism film. The observed results are shown in Table 2.

TABLE 1
Unit: %

| | Overall | Cross-sectional direction to CCFLs | | | | | | | | |
|---|---|---|---|---|---|---|---|---|---|---|
| | transmittance of | Parallel direction | | | Perpendicular | | | | | |
| | diffusion plate | (a) | | | direction (b) | | | Direction of 45° (c) | | |
| | (%) | 15° | 30° | 45° | 15° | 30° | 45° | 15° | 30° | 45° |
| Example 1 | 75 | 95.7 | 56.8 | 12.8 | 92.7 | 55.2 | 39.6 | 91.8 | 57.5 | 19.4 |
| Example 2 | 75 | 93.7 | 59.2 | 19.6 | 91.7 | 53.4 | 16.2 | 93.8 | 55.9 | 12.6 |
| Example 3 | 65 | 94.8 | 54.0 | 12.1 | 93.8 | 53.8 | 40.6 | 93.1 | 53.6 | 16.1 |
| Example 4 | 65 | 94.0 | 60.0 | 17.1 | 91.7 | 52.3 | 14.5 | 95.5 | 55.6 | 13.9 |
| Example 5 | 75 | 92.3 | 52.8 | 13.7 | 94.3 | 47.2 | 33.6 | 92.5 | 52.9 | 15.2 |
| Example 6 | 75 | 91.8 | 53.1 | 12.9 | 93.1 | 53.4 | 14.4 | 90.4 | 50.6 | 13.3 |
| Example 7 | 65 | 92.9 | 52.7 | 13.6 | 93.4 | 47.0 | 30.7 | 91.2 | 51.8 | 13.7 |
| Example 8 | 65 | 92.5 | 51.2 | 14.1 | 90.3 | 50.9 | 13.4 | 89.4 | 51.0 | 13.5 |

TABLE 2
Unit: %

| | Overall | Cross-sectional direction to CCFLs | | | | | | | | |
|---|---|---|---|---|---|---|---|---|---|---|
| | transmittance of | Parallel direction | | | Perpendicular | | | | | |
| | diffusion plate | (a) | | | direction (b) | | | Direction of 45° (c) | | |
| | (%) | 15° | 30° | 45° | 15° | 30° | 45° | 15° | 30° | 45° |
| Comparative | 75 | 96.8 | 89.9 | 75.6 | 93.6 | 76.4 | 19.6 | 96.7 | 82.5 | 21.4 |
| Example 1 | | | | | | | | | | |
| Comparative | 75 | 95.4 | 87.4 | 72.2 | 95.0 | 80.8 | 14.5 | 97.5 | 87.5 | 22.8 |
| Example 2 | | | | | | | | | | |
| Comparative | 75 | 97.2 | 88.1 | 77.7 | 97.4 | 84.1 | 73.4 | 99.9 | 87.9 | 74.5 |
| Example 3 | | | | | | | | | | |
| Comparative | 65 | 98.4 | 93.7 | 83.2 | 97.9 | 83.5 | 18.0 | 98.4 | 87.2 | 20.3 |
| Example 4 | | | | | | | | | | |
| Comparative | 65 | 98.2 | 93.7 | 82.6 | 98.0 | 87.4 | 11.5 | 97.8 | 92.6 | 30.3 |
| Example 5 | | | | | | | | | | |
| Comparative | 65 | 97.9 | 94.5 | 89.1 | 99.9 | 97.2 | 90.3 | 99.9 | 97.2 | 90.0 |
| Example 6 | | | | | | | | | | |

The illumination devices according to the present invention in Examples 1 to 8 demonstrate excellent light collection performance in the cross sections a, b, and c, which were cut in parallel, perpendicular, and at the direction of 45°, respectively, as shown in Tables 1 and 2. In contrast, the light collection performance was insufficient in the illumination devices in Comparative Examples 1 to 6.

### INDUSTRIAL APPLICABILITY

In the illumination device according to the present invention, the light emitted from the light source is diffused by the light diffusion plate and then collected in the front direction. Thus, high luminance is achieved in the front direction.

### REFERENCE SIGNS LIST

1 Light source
2 Light diffusion plate (light diffusion means)
3 Light-collecting means
4 Light guide plate (light diffusion means)
11 CCFL (cold cathode fluorescent lamp)
31, 32 Prism film
33, 34 Prism film

1. An illumination device comprising, disposed in sequence:
a light source;
a light diffusion means; and
a light-collecting means, wherein
the light-collecting means comprises two prism films provided with a plurality of linear prisms disposed in parallel, each prism having a triangular cross section on a light incident surface, and the two prism films are disposed such that ridge lines of the linear prisms are orthogonal to each other.

2. The illumination device according to claim 1, wherein the light diffusion means is a light diffusion plate, and the light source is provided so as to face the light diffusion plate.

3. The illumination device according to claim 1, wherein the light source comprises a plurality of linear light source elements disposed in parallel.

4. The illumination device according to claim 1, wherein the light diffusion means is a light guide plate, and the light source is provided so as to face a side surface of the light guide plate.

5. The illumination device according to claim 1, wherein the light incident surfaces of the two prism films have a center-line average roughness Ra of 0.3 μm or less and a ten-point average roughness Rz of 1 μm or less.
